(19) United States
(12) Patent Application Publication
(10) Pub. No.: US 2026/0143094 A1
(43) Pub. Date: May 21, 2026

(54) BRIGHTNESS ENHANCEMENT FOR LASER BEAM SCANNING PROJECTION SYSTEM

(71) Applicant: STMicroelectronics International N.V., Geneva (CH)

(72) Inventors: Chia Feng YANG, Taoyuan (TW); Cheng Lin TSAI, New Taipei City (TW); Davide TERZI, Zanica (IT)

(21) Appl. No.: 18/954,961

(22) Filed: Nov. 21, 2024

(51) Int. Cl. H04N 9/31

(52) U.S. Cl. CPC H04N 9/3129; H04N 9/3161

(57) ABSTRACT

An example laser beam scanning projection system, a method for modulating an optical output of a laser beam scanning projection system, and a head-worn display are provided. The example laser beam scanning projection system includes an optical engine, a scanning system, and a controller. The optical engine generates an optical output corresponding to a pixel location in a display image. The scanning system projects the optical output to the pixel location on a display surface displaying the display image. The controller determines a minimum pixel brightness associated with the display image, and a maximum pixel brightness. The controller further determines a modulated region of the display image based on the maximum pixel brightness. The controller adjusts an optical output brightness of the optical output such that a pixel brightness at the pixel location is at the maximum pixel brightness for pixel locations in the modulated region.

### TECHNOLOGICAL FIELD

Embodiments of the present disclosure relate generally to laser beam scanning projection systems, and more particularly, to enhancing the brightness of a laser beam scanning projection system.

### BACKGROUND

Laser beam scanning projection systems utilize a scanning system to control deflection of laser beams to project images or video onto a surface in rapid, precise patterns. By varying the intensity and color of the laser beam, a high-resolution image may be generated. Laser beam scanning may utilize various mechanisms to miniaturize the projection system. For example, mirrors controlled by microelectromechanical systems (MEMS) may be used to precisely direct the laser beam on a projection surface. Miniaturized projection systems utilizing laser beam scanning have seen rapid growth, particularly as a high-resolution, large field of view, and high refresh rate projection solution in area and power constrained applications. For example, laser beam scanning projection systems have been widely adopted in augmented reality, mixed reality, and lidar applications.

Applicant has identified many technical challenges and difficulties associated with displaying an image on a display surface using a laser beam scanning projection system. Through applied effort, ingenuity, and innovation, Applicant has solved problems related to displaying images using a laser beam scanning projection system by developing solutions embodied in the present disclosure, which are described in detail below.

### BRIEF SUMMARY

Various embodiments are directed to an example apparatus, a method for modulating an optical output of a laser beam scanning projection system, and a head-worn display comprising a laser beam scanning projection system.

An example apparatus comprising an optical engine, a scanning system, and a controller. The optical engine configured to generate an optical output corresponding to a pixel location in a display image. The scanning system configured to project the optical output to the pixel location on a display surface displaying the display image. The controller configured to determine a minimum pixel brightness associated with the display image; determine a maximum pixel brightness greater than the minimum pixel brightness; determine a modulated region of the display image based on the maximum pixel brightness; determine the pixel location is within the modulated region; and adjust an optical output brightness of the optical output such that a pixel brightness at the pixel location is at the maximum pixel brightness.

In some embodiments, the maximum pixel brightness is 120% of the minimum pixel brightness.

In some embodiments, the minimum pixel brightness is based on a center pixel brightness corresponding to a center pixel location proximate a center of the display image.

In some embodiments, the scanning system is configured to project the optical output associated with a plurality of pixel locations in a raster pattern.

In some embodiments, the modulated region is determined based on a distance from a center line of the display image.

In some embodiments, the modulated region is defined by a maximum lateral distance from the vertical center line of the display image.

In some embodiments, the maximum lateral distance corresponds to a point at which a corresponding pixel brightness exceeds the maximum pixel brightness.

In some embodiments, the pixel brightness is measured in lux.

In some embodiments, the pixel brightness is based on an optical output dwell time.

An example method for modulating an optical output of a laser beam scanning projection system is also provided. The example method comprising: causing an optical engine to generate the optical output corresponding to a pixel location in a display image, wherein the optical output is directed by a scanning system to the pixel location on a display surface displaying the display image; determining a minimum pixel brightness associated with the display image; determining a maximum pixel brightness greater than the minimum pixel brightness; determining a modulated region of the display image based on the maximum pixel brightness; determining the pixel location is within the modulated region; and adjusting an optical output brightness of the optical output such that a pixel brightness at the pixel location is at the maximum pixel brightness.

In some embodiments, the maximum pixel brightness is 120% of the minimum pixel brightness.

In some embodiments, the minimum pixel brightness is based on a center pixel brightness corresponding to a center pixel location proximate a center of the display image.

In some embodiments, the scanning system is configured to project the optical output associated with a plurality of pixel locations in a raster pattern.

In some embodiments, the method further comprises determining a maximum lateral distance from a vertical center line of the display image corresponding to a point at which a corresponding pixel brightness exceeds the maximum pixel brightness; and defining the modulated region based on the maximum lateral distance from the vertical center line of the display image.

In some embodiments, any pixel location having a pixel lateral distance from the vertical center line of the display image exceeding the maximum lateral distance is within the modulated region of the display image.

In some embodiments, the pixel brightness is measured in lux.

In some embodiments, the pixel brightness is based on an optical output dwell time.

A head-worn wearable display is also provided. In some embodiments, the head-worn wearable display comprises a display surface, and a laser beam scanning projection system. In some embodiments, the laser beam scanning projection system is configured to project a display image on the display surface. The laser beam projection system comprises an optical engine, a scanning system, and a controller. The optical engine is configured to generate an optical output corresponding to a pixel location on the display surface. The scanning system is configured to project the optical output to the pixel location on the display surface. The controller is configured to: determine a minimum pixel brightness associated with the display surface; determine a maximum pixel brightness greater than the minimum pixel brightness; determine a modulated region of the display surface based on the maximum pixel brightness; determine the pixel location is within the modulated region; and adjust an optical output brightness of the optical output such that a pixel brightness at the pixel location is at the maximum pixel brightness.

In some embodiments, the maximum pixel brightness is 120% of the minimum pixel brightness.

In some embodiments, the display surface is transparent.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a block diagram of an example laser beam scanning projection system in accordance with an example embodiment of the present disclosure.

FIG. 2 illustrates an example laser beam scanning projection system in accordance with an example embodiment of the present disclosure.

FIG. 3 illustrates an example brightness distribution on a display generated by a laser beam scanning projection system.

FIG. 4 illustrates an example process for modulating an optical output of a laser beam scanning projection system in accordance with an example embodiment of the present disclosure.

FIG. 5 illustrates a flow diagram depicting an example embodiment of a process for modulating an optical output of a laser beam in accordance with an example embodiment of the present disclosure.

FIG. 6 illustrates an example brightness distribution of a modulated optical output in accordance with an example embodiment of the present disclosure.

FIG. 7 depicts an example head-worn wearable device comprising a laser beam scanning projection system in accordance with an example embodiment of the present disclosure.

FIG. 8 depicts a block diagram of an example architecture of a controller in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with enhancing the brightness of an image generated by a laser beam scanning projection system. As understood by those of skill in the field to which the present disclosure pertains, there are numerous example systems which may benefit from enhanced brightness of a laser beam scanning projection system.

For example, a laser beam scanning projection system is a projection system that utilizes the controlled deflection of optical output to project images or video onto a display surface. Laser beam scanning involves directing laser beams toward a surface in rapid, precise patterns (e.g., a raster pattern). By varying the intensity and color of the laser beam based on a pixel location, a high-resolution image may be generated. Laser beam scanning may utilize various mechanisms to miniaturize the projection system. For example, mirrors controlled by microelectromechanical systems (MEMS) may be used to precisely direct the laser beam on a projection surface. Miniaturized projection systems utilizing laser beam scanning have seen rapid growth, particularly as a high-resolution, large field of view, and high refresh rate projection solution in area and power constrained applications. For example, laser beam scanning projection systems have been widely adopted in augmented reality, mixed reality, and lidar applications.

Many laser beam scanning projection system utilize raster scanning with MEMS mirrors to direct and control a laser beam on a display surface in a systematic pattern to generate an image. In such an approach, MEMS mirrors steer the laser beam along two axes (e.g., horizontal and vertical) to generate pixels at pixel locations in rows and columns. MEMS mirrors are tine, fast-acting mirrors that can tilt or rotate on one or more axes in response to electrical signals. In a scanning system on a laser beam scanning projection system, one mirror typically handles movement in a horizontal direction, while a second mirror controls movement in a vertical direction.

In a raster scanning process, the pixels of the image are generated sequentially in a horizontal line. The first horizontal line is completed, then the scanning system directs the laser beam down a row and the second horizontal row is generated, and so on, until the final row of the image is generated. In a traditional raster scanning process, the horizontal axis scans quickly as the scanning system moves the laser beam back and forth across each line generating the pixels in a single row. However, the vertical axis moves more slowly, shifting the laser beam down one line at a time after a complete horizontal sweep.

An image is made of a two-dimensional array of pixels. In a laser beam scanning projection system, a pixel is generated by controlling the laser beam color and brightness based on the pixel location and directing the laser beam to the pixel location on the display image associated with the pixel. Each pixel location is associated with a color and a brightness. The color may be a red-green-blue (RGB) value corresponding to the intensity of red light, green light, and blue light combined to generate the optical output. The brightness of a pixel corresponds to the amount of light from the laser beam that is projected on the pixel location. Essentially, the brightness of a pixel indicates how bright a surface appears when illuminated by a light source. The brightness of a pixel may be measured in lux, a unit of illuminance. Lux indicates the amount of light that reflects from a surface per unit area. Thus, pixel brightness is the amount of light that reflects from the pixel location corresponding to the pixel. In some embodiments, the pixel brightness may be determined by measuring the projector brightness, for example, the brightness of the optical output in Lumens.

In a laser beam scanning projection system generating an image in a raster pattern, the pixel brightness at each pixel location may depend on the speed of the MEMS mirrors directing the optical output to the pixel location. For example, in an instance in which a MEMS mirror moves quickly across a pixel location, less light falls on the pixel location and the pixel brightness of the pixel is less. However, as the MEMS mirror slows down, more light falls on the pixel location and the pixel brightness of the pixel is greater. When moving in a raster pattern, often the MEMS mirrors move quickly through the center portions of the image when generating pixels and move more slowly as the MEMS mirror changes directions at the edge portions of the image. Thus, when the optical output is driven by a constant current, the brightness at the edge portions of a projected image will be greater than at the center portion. This non-uniformity in image brightness may adversely affect the quality of an image.

In some examples, a modulation algorithm is used to reduce the brightness of the pixels near the edges of the projected image to match, or nearly match, the brightness of the pixels near the center portion of the projected image. However, reducing the brightness of the pixels near the edges of the projected image to match the brightness of the pixels at the center of the image reduces the overall brightness of the projected image, also affecting the overall quality of the image.

The various example embodiments of the present disclosure provide a laser beam scanning projection system configured to enhance the overall brightness of the projected image. The laser beam scanning projection system according to the present disclosure utilizes a controller to determine a modulated region and an unmodulated region based on the brightness of the pixels in the region. For example, the modulated region may be determined based on the relative brightness of the pixels compared to a minimum pixel brightness. The minimum pixel brightness corresponds to the one or more pixels associated with the least brightness. In some embodiments, the pixels associated with the minimum pixel brightness may be correlated to the speed of the MEMS mirrors. For example, the pixels associated with the minimum pixel brightness may be at or near the center portion of the display image, where the scanning MEMS mirror is moving the fastest.

Once the minimum pixel brightness is determined, a maximum pixel brightness may be used to set the boundaries of the modulated region. For example, a variation of pixel brightness within 20% may be imperceptible to the human eye. Thus, a maximum pixel brightness may be set at 120% of the minimum pixel brightness. The boundaries of the modulated region may be set at a distance from the pixels exhibiting the minimum pixel brightness beyond which, the pixel brightness of the pixels exceed the maximum pixel brightness.

During operation of the laser beam scanning projection system, pixels having pixel locations within the unmodulated region are displayed normally. However, the brightness of pixels having pixel locations within the modulated region is modified. For example, the intensity of the optical output for pixels having pixel locations within the modulated region is reduced, such that the pixel brightness of the pixels within the modulated region does not exceed the maximum pixel brightness.

As a result of the herein described example embodiments and in some examples, the overall brightness of an image displayed using a laser beam scanning projection system is enhanced. The enhanced brightness of the displayed image enhances the overall quality of the image without perceptibly affecting the uniformity of the displayed image.

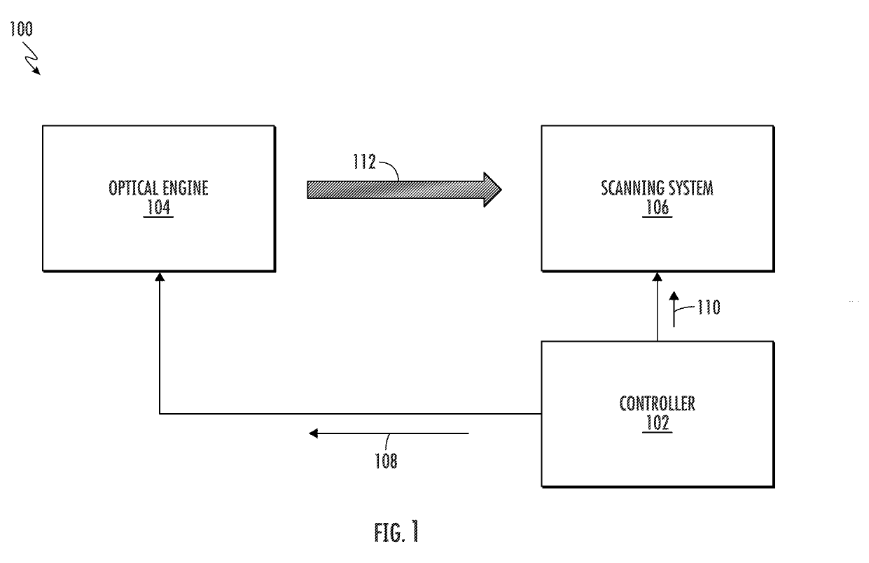

Referring now to FIG. 1, an example laser beam scanning projection system 100 is provided. As depicted in FIG. 1, the example laser beam scanning projection system 100 includes an optical engine 104 configured to transmit optical output 112 directed toward a scanning system 106. As further depicted in FIG. 1, the laser beam scanning projection system 100 includes a controller 102 electrically connected to both the optical engine 104 and the scanning system 106 and configured to transmit optical control signals 108 to the optical engine 104 and scanning control signals 110 to the scanning system 106.

As depicted in FIG. 1, the laser beam scanning projection system 100 includes an optical engine 104. An optical engine 104 comprises any light source or array of light sources comprising a semiconductor, diode, laser, or other photon emitting structure configured to generate optical output 112. some embodiments, the optical engine 104 may comprise one or more vertical cavity surface emitting lasers (VCSELs). The optical engine 104 may be configured, for example by optical control signals 108, to define the color and brightness of the optical output 112.

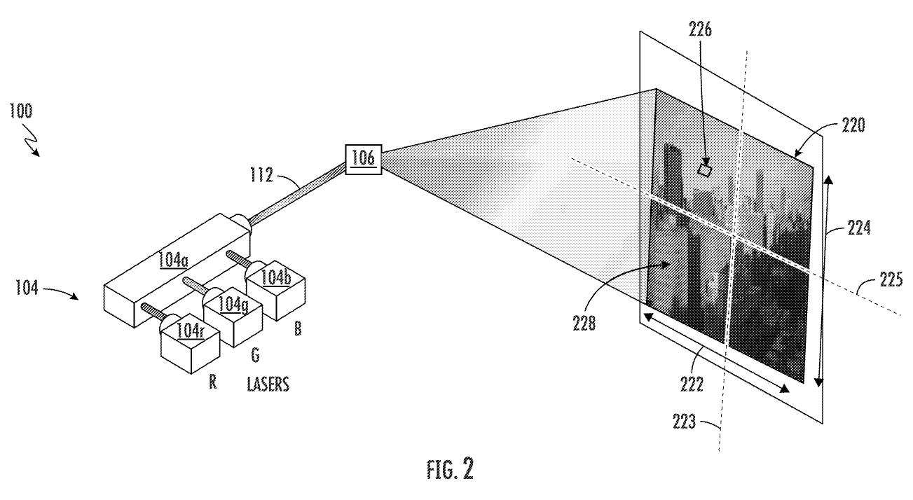

In some embodiments, the optical engine 104 may utilize a plurality of light sources to define the color of the optical output 112. For example, each light source in the plurality of light sources may be configured to output light having a different color (e.g., wavelength). The intensity of each light source may be varied based on the desired color of the optical output 112. The output from each light source may then be combined into an optical output 112 having the desired color. An example optical engine 104 comprising a plurality of light sources is described in relation to FIG. 2.

In some embodiments, the brightness of the optical output 112 may be varied based on a drive current provided to the one or more light sources included in the optical engine 104. For example, increasing the drive current provided to the one or more light sources may increase the brightness of the optical output 112 generated by the optical engine 104. Conversely, decreasing the drive current provided to the one or more light sources may decrease the brightness of the optical output 112 generated by the optical engine 104.

In a laser beam scanning projection system 100, the optical output 112 is configured to correspond with a pixel in a display image. A pixel is the smallest controllable element that forms the details and colors in a display image. Each pixel is associated with a pixel location, a color, and an intensity. A display image comprises a plurality of pixels arranged in a pattern. For example, in a two-dimensional image, the pixels are arranged in a two-dimension grid array. When combined in a pattern, the plurality of pixels form the display image. Thus, the color and intensity of the optical output 112 is adjusted based on the pixel location of the corresponding pixel.

As further depicted in FIG. 1, the laser beam scanning projection system 100 includes a scanning system 106. A scanning system 106 comprises any optical components, including mirrors, lenses, and other optical devices configured to receive an optical output 112 and direct the optical output 112 to a corresponding location on a display surface. For example, in an instance in which the optical output 112 corresponds to a pixel in a display image, the scanning system 106 is synchronized with the optical engine 104 to direct the optical output 112 to a corresponding pixel location on the display surface. Thus, each pixel location receives the corresponding color and intensity of the optical output 112 to generate a display image on the display surface.

In some embodiments, the scanning system 106 may direct optical output 112 to corresponding pixel locations in a raster pattern. A raster pattern is a process by which the pixels of a display image are generated sequentially in a first direction, one line at a time. After completion of a line, the pattern moves to the next line, in a second direction. The pattern continues until all pixels are generated. For ease of explanation, the raster pattern herein is described as displaying pixels sequentially in a horizontal direction one line at a time and moving in a vertical direction after each horizontal line is complete. However, a raster pattern could just as easily scan sequentially in a vertical direction one line at a time and move in a horizontal direction after each vertical line is complete.

A scanning mechanism of the scanning system 106 following a raster pattern moves across the scanning line very quickly in comparison to the slow movement between lines. For example, when scanning across the line in a horizontal direction, the scanning mechanism of the scanning system 106 moves quickly in the horizontal direction compared to the vertical direction. Further, the scanning mechanism slows at it nears the edges of the display image and changes direction. Thus, the scanning mechanism moves faster through the center portion of the image compared to the side portions. Since the brightness of the pixels are affected by the speed of the scanning mechanism, the variation of the scanning mechanism may have an adverse affect on the quality of the display image.

In some embodiments, the scanning system 106 may comprise one or more MEMS mirrors. The one or more MEMS mirrors are configured to direct the optical output generated by the optical engine 104 for a particular pixel to the corresponding pixel location. For example, a scanning system 106 may comprise two MEMS mirrors configured to steer the optical output along two axes (e.g., horizontal and vertical). In a raster pattern, the horizontal MEMS mirror may move quickly to scan the pixels across a horizontal line of the display image while the vertical MEMS mirror moves slower relative to the horizontal MEMS mirror.

Although depicted separate from the optical engine 104 in FIG. 1, in some embodiments, the scanning system 106 may be integrated with the optical engine. For example, the optical engine may include a light source, MEMS mirrors, and associated sensors to generate the optical output 112 and direct the optical output 112 at the associated pixel location.

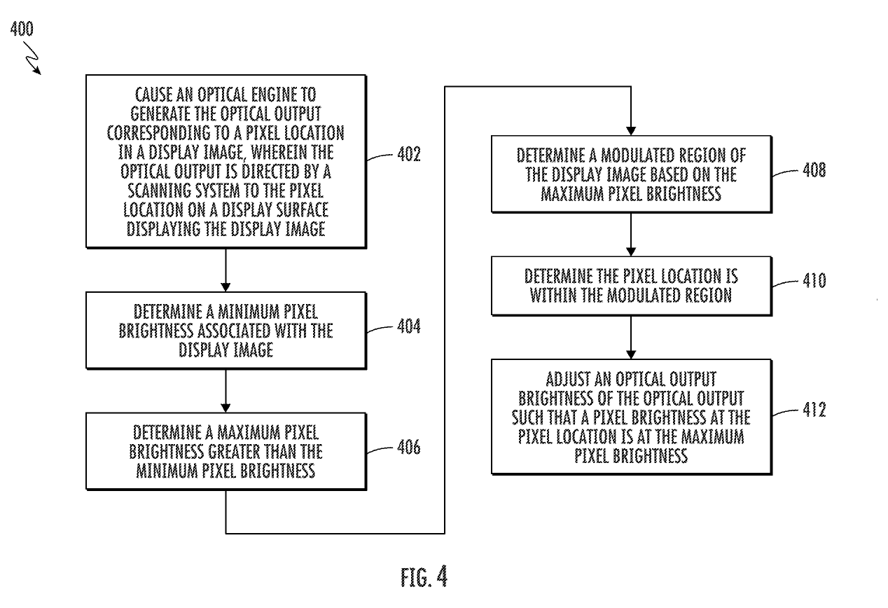

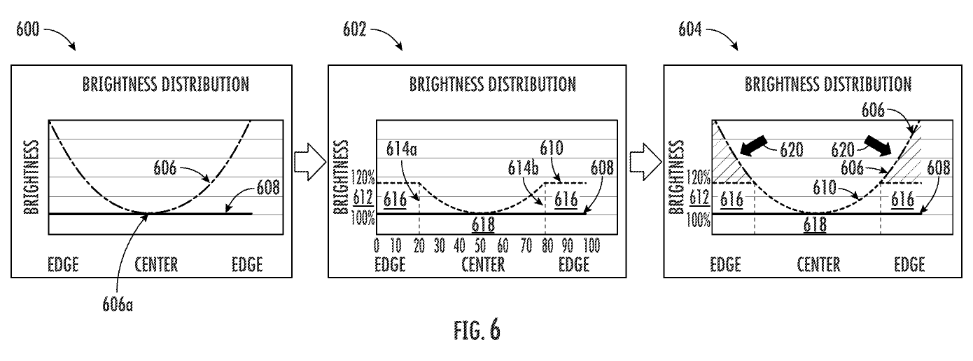

As further depicted in FIG. 1, the laser beam scanning projection system 100 includes a controller 102. A controller 102 comprises any circuitry including hardware and/or software configured to transmit optical control signals 108 and scanning control signals 110 to control aspects of the optical engine 104 and the scanning system 106 respectively. The controller 102 is further configured to perform the functions of the process for modulating the optical output 112 of the laser beam scanning projection system 100 as further described in FIG. 4 – FIG. 6.

As further depicted in FIG. 1, the controller 102 is configured to generate optical control signals 108. Optical control signals 108 may be utilized to control the color and brightness of the optical output 112. For example, the controller 102 may transmit the color parameters corresponding to each pixel location in a display image. Further, the controller 102 may determine the brightness of the optical output 112 for each pixel location. The brightness of the optical output 112 may be defined in terms of lumens. Lumens are a unit of luminous flux and measures the perceived power of visible light emitted by the optical engine 104. The brightness of the optical output 112 directly correlates to the pixel brightness (e.g., measured in lux) at the pixel location on the display surface. The controller 102 may control the brightness of the optical output 112 for each pixel location through the optical control signal 108. In some embodiments, the optical control signal 108 may control the drive current of the optical engine 104 to adjust the brightness of the optical output 112. For example, a reduction in the drive current results in a reduced brightness of the optical output 112 which results in a reduced brightness of the pixel in the display image.

As further depicted in FIG. 1, the controller 102 is configured to generate scanning control signals 110. The scanning control signals 110 may manage the operation of the scanning system 106. For example, the controller 102 may utilize scanning control signals 110 to coordinate the optical output 112 with the scanning system 106 to direct a pixel color and brightness to the corresponding pixel location defined by the scanning system 106.

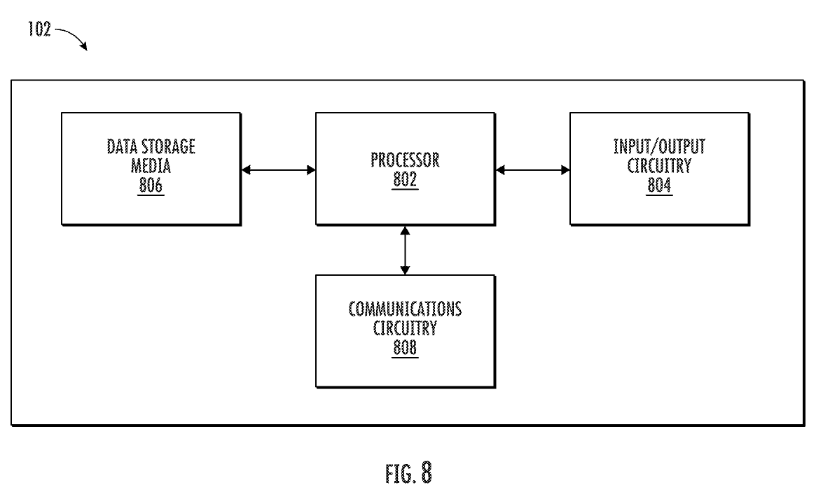

An example architecture of a controller 102 is depicted and further described in relation to FIG. 8. Although depicted as a single controller 102 in FIG. 1, the various operations performed by the controller 102 may be divided amongst one or more controllers. For example, in some embodiments, the determination of the modulated region may be performed by a first controller, for example during a calibration process. The first controller may determine modulation boundaries which are written to a memory location accessible by a second controller. The second controller may utilize the determined modulation boundaries to transmit optical control signals 108 and scanning control signals 110 in accordance with the modulation process.

Referring now to FIG. 2, and example embodiment of a laser beam scanning projection system 100 is provided. As depicted in FIG. 2, the example laser beam scanning projection system 100 includes an optical engine 104 configured to generate an optical output 112 directed at a scanning system 106. The optical engine 104 comprising a red optical source 104r, a green optical source 104g, a blue optical source 104b, and a beam combiner 104a. The scanning system 106 directs the optical output 112 to generate a display image 228 comprising a plurality of pixels 226 on a display surface 220. As further depicted in FIG. 2, the display image 228 comprises a display image width 222 and a display image height 224.

As depicted in FIG. 2, the example optical engine 104 includes a red optical source 104r, a green optical source 104g, a blue optical source 104b, and a beam combiner 104a. The optical engine 104 is configured to control the color and brightness of each pixel 226 in the display image 228. As depicted in FIG. 2, the color of the pixel may be defined based on a combination of red, green, and blue elements, according to an RGB color model. In some embodiments, the controller (e.g., controller 102 described in relation to FIG. 1) may indicate the red, green, and blue values associated with the color of a particular pixel. For example, an RGB value of a pink pixel may be associated with an RGB value of (255 red, 105 green, 180 blue) where each value corresponds to an intensity of the red optical source 104r, green optical source 104g, and blue optical source 104b respectively. The optical engine 104 may update the output of the red optical source 104r, green optical source 104g, and blue optical source 104b accordingly to generate the desired pixel color. The red output from the red optical source 104r, the green output from the green optical source 104g, and the blue output from the blue optical source 104b are combined with a beam combiner 104a to generate the optical output 112.

Similarly, the brightness of each pixel is controlled by regulating the drive current to each optical source (e.g., red optical source 104r, green optical source 104g, blue optical source 104b). In some embodiments, the controller may manage the drive current to the optical engine 104, for example, through one or more optical control signals. Thus, the brightness of the generated optical output 112 may be adjusted based on the pixel brightness of a pixel 226 on a display image 228.

As further depicted in FIG. 2, the example laser beam scanning projection system 100 includes a scanning system 106. The scanning system 106 is configured to direct the optical output 112 to a corresponding pixel location to generate a display image 228 on a display surface 220.

As further depicted in FIG. 2, the example laser beam scanning projection system 100 is configured to direct the optical output 112 toward a display surface 220. A display surface 220 comprises a surface or plurality of surfaces configured to reflect at least a portion of the optical output generated by the optical engine 104 and directed by the scanning system 106 such that a display image 228 may be viewed. In some embodiments, a display surface 220 may comprise an opaque surface such as a screen, wall, or other opaque surface. In some embodiments, a display surface 220 may comprise a transparent or semi-transparent surface, for example one or more lenses on smart glasses, or an augmented reality system. In such an embodiment, the projection and or lens may be configured to reflect the optical output 112 toward a user.

As further depicted in FIG. 2, the example laser beam scanning projection system 100 is configured to generate a display image 228. A display image 228 comprises any visual representation comprising one or more pixels 226 projected onto a display surface. A display image 228 may comprise a plurality of pixels 226 arranged in a pattern wherein each pixel 226 is associated with a pixel location, a pixel brightness, and a pixel color. When combined in a pattern, the color, location, and intensity of the plurality of pixels 226 form the display image 228. As depicted in FIG. 2, the display image 228 is arranged in a two-dimensional pattern having a display image width 222 and a display image height 224.

A pixel location associated with a pixel 226 may be defined based on the location of the pixel 226 within the pattern of pixels. For example, in the two-dimensional pattern depicted in FIG. 2, a pixel location of a pixel 226 may be defined based on an x, y location. Where the x location represents the horizontal location of the pixel 226 from the edge of the display image 228 and the y location represents the vertical location of the pixel 226 from the top of the display image 228.

As further depicted in FIG. 2, a vertical center line 223 of the display image 228 is equidistant from each of the vertical sides of the display image 228. Similarly, a horizontal center line 225 of the display image 228 is equidistant from each of the horizontal sides of the display image 228. The center of the image is at the intersection of the horizontal center line 225 and the vertical center line 223 of the display image 228.

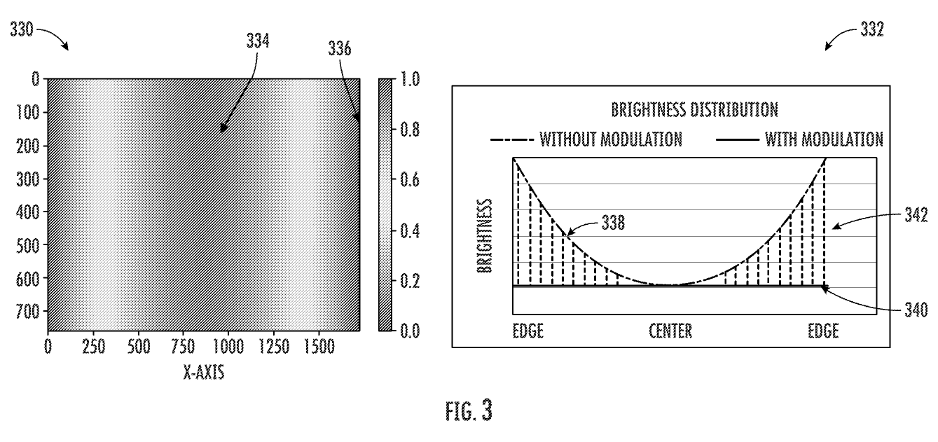

Referring now to FIG. 3, an example graph 330 representing the speed of the scanning mechanism of a scanning system (e.g., scanning system 106) directing the optical output (e.g., optical output 112) is provided. As depicted in FIG. 3, the shading of each location of the graph 330, depicts the speed of the scanning mechanism when projecting an optical output at the corresponding pixel location of the display image. For example, in an instance in which the scanning mechanism moves in a raster pattern, the horizontal scanning mechanism moves quickly through the center portion 334 of the display image. However, as the horizontal scanning system approaches the vertical edge portion 336 of the display image, the horizontal scanning mechanism begins to slow. Further, as the horizontal scanning mechanism changes directions at the edge portion 336 of the display image and begins to speed up again as it directs optical output through the center portion 334 of the screen. Thus, as shown in FIG. 3, the horizontal scanning mechanism of the scanning system moves quickly through the center portion of the display image, and relatively slow through the edge portions of the display image.

The speed of the scanning mechanism is inversely proportional to the dwell time of the optical output at each pixel location in a display image. The faster the scanning mechanism is moving the shorter the dwell time. Similarly, the slower the scanning mechanism is moving, the longer the dwell time. Further, the brightness is of a pixel is directly proportional to the dwell time at the pixel location. As the dwell time increases, the brightness of the pixel increases, and, as the dwell time decreases, the brightness of the pixel decreases.

The example graph 332 depicts the corresponding brightness distribution across a horizontal cross section of a display image. As depicted in graph 332, the brightness 338 of the pixels is at a minimum at or near the center portion of a display image and increases near the edges of the display image. The brightness 338 of the pixels in a horizontal cross section of a display image is shown compared to a minimum pixel brightness 340 observed at or near a center portion of the display image. As depicted in graph 332, the brightness difference 342 at or near the edges of a display image may be significantly higher than the brightness difference 342 at or near the center of the display image. Such a discrepancy in brightness may adversely affect the quality of a display image.

Referring now to FIG. 4, an example process 400 for modulating an optical output (e.g., optical output 112) of a laser beam scanning projection system (e.g., laser beam scanning projection system 100) is provided. At block 402, a controller (e.g., controller 102) causes an optical engine (e.g., optical engine 104) to generate the optical output corresponding to a pixel location in a display image (e.g., display image 228), wherein the optical output is directed by a scanning system (e.g., scanning system 106) to the pixel location on a display surface (e.g., display surface 220) displaying the display image.

The controller of the laser beam scanning projection system is electrically connected to both the optical engine and the scanning system, enabling the controller to synchronize the projection of image pixels having a specified pixel color and pixel brightness to a corresponding pixel location. For example, the controller may transmit one or more optical control signals (e.g., optical control signals 108) to the optical engine specifying the color and brightness of one or more pixels. The controller may further transmit one or more scanning control signals (e.g., scanning control signals 110) to the scanning system correlating the pixel locations with the corresponding pixel color and brightness.

In some embodiments, the scanning system may render the pixels of the display image on the display surface in a raster pattern. For example, the scanning system may direct the optical output for each pixel to the corresponding pixel location sequentially across a horizontal line of the display image, and continue, line by line, from the top of the display image to the bottom of the display image. When transmitted with a constant current, displaying according to a raster pattern may cause varying optical output dwell times at each pixel location based on the speed of the scanning mechanisms comprising the scanning system. The varying optical output dwell times may cause varying pixel brightness based on the pixel location.

At block 404, the controller determines a minimum pixel brightness (e.g., minimum pixel brightness 340) associated with the display image. The brightness of each pixel represents the amount of light that reflects from the display surface at the pixel location. Thus, pixel brightness is the amount of light that falls on the pixel location corresponding to the pixel. In some embodiments, the brightness of a pixel may be measured in lux, a unit of illuminance.

The controller may utilize any mechanism to determine, predict, and/or estimate the minimum pixel brightness. In one example, the controller may measure the pixel brightness (in lux) at various locations across the display surface and select the lowest observed pixel brightness as the minimum pixel brightness. For example, the controller may perform a measurement at 0% of the display surface width, 10%, 20%, 30%, and so on, across the width of the display surface. In another example, the controller may leverage known brightness levels of the pixel locations when pixels are displayed in a raster pattern. For example, the controller may select the brightness of a pixel at a pixel location at the vertical center line of the display image as the minimum pixel brightness. The vertical center line is the line that is equidistant from both vertical edges of the display image. In an instance in which pixels are rendered in a raster pattern, the pixel locations at or near the vertical center line usually have the lowest brightness values since the scanning system is moving the fastest at these points. In another example, the controller may determine the center pixel location of the display image proximate the intersection of the vertical center line and the horizontal line and utilize the observed pixel brightness at the center pixel location as the minimum pixel brightness.

In other examples, the controller may utilize the speed of the scanning system and/or the optical output dwell time to determine the minimum pixel brightness. For example, the pixel location corresponding to the maximum speed of the scanning system may be used to determine the minimum pixel brightness. Similarly, the pixel location corresponding to the minimum optical output dwell time may be used to determine the minimum pixel brightness.

At block 406, the controller determines a maximum pixel brightness greater than the minimum pixel brightness. The controller may utilize any mechanism to determine a maximum pixel brightness greater than the minimum pixel brightness. For example, the maximum pixel brightness may be a percentage in excess of the minimum pixel brightness (e.g., 10% greater than the minimum pixel brightness). Variations in pixel brightness within 20% may be imperceptible to the human eye. Thus, a maximum pixel brightness may be set at or near 120% of the minimum pixel brightness without adversely affecting the quality of the display image. In some embodiments, the maximum pixel brightness may be between 15% and 20% greater than the minimum pixel brightness; more preferably between 17% and 20% greater than the minimum pixel brightness; most preferably between 19% and 20% greater than the minimum pixel brightness, so as to enable maximum pixel brightness without adversely affecting the image quality.

At block 408, the controller determines a modulated region of the display image based on the maximum pixel brightness. The controller may define the modulated region based on the pixel brightness at pixel locations on the display image. For example, any pixel location exceeding the maximum pixel brightness is included in the modulated region.

In some examples, the controller may determine a maximum distance from a center portion of the display image beyond which the pixel brightness of the corresponding pixel locations primarily exceed the maximum pixel brightness. For example, a controller may measure the pixel brightness of pixel locations progressively farther from the center portion (e.g., center point or center line). In an instance in which the controller determines the pixel brightness of a particular pixel location exceeds the maximum pixel brightness, the controller may determine the distance between the center portion and the particular pixel location. The determined distance may be used as a maximum distance used to define the modulated region. For example, any pixel location further than the maximum distance from the center portion (e.g., center point or center line) is included in the modulated region.

In an instance in which pixels are rendered according to a raster pattern in a horizontal scan line, the controller may determine the modulated region based on horizontal location (e.g., x location), where the horizontal location represents the distance of a pixel location from a vertical edge. For example, the controller may determine a minimum horizontal location and a maximum horizontal location. Any pixels having a pixel location below the minimum horizontal location or pixel locations above the maximum horizontal location may be included in the modulated region. In some embodiments, the boundaries of the modulated region may be determined by measuring the pixel brightness across a horizontal line of the display image. Further, in some embodiments, the controller may step across a horizontal line of the display image according to a regular interval and measure the pixel brightness. For example, the controller may measure the brightness at 5% of the width of the display image, then 10%, then 15%, then 20%, and so on.

In some embodiments, the modulated region may be defined based on the speed of the scanning system. For example, any pixel locations corresponding to a scanning system speed slower than a minimum scanning system speed (e.g., resulting in a pixel brightness exceeding the maximum pixel brightness) may be included in the modulated region.

In some embodiments, the modulated region may be defined based on the optical output dwell time of the pixel location. For example, any pixel locations corresponding to an optical output dwell time longer than maximum optical output dwell time (e.g., resulting in a pixel brightness exceeding the maximum pixel brightness) may be included in the modulated region.

In some embodiments, the modulated region may be determined during a calibration process, for example, during manufacturing and stored within the laser beam scanning projection system. In some embodiments, the various operations performed by the controller of the process 400 may be divided amongst one or more controllers. For example, in some embodiments, the determination of the modulated region may be performed by a first controller, for example during the calibration process. The first controller may determine modulation boundaries which are written to a memory location accessible by a second controller. The second controller may utilize the determined modulation boundaries to transmit optical control signals 108 and scanning control signals 110 in accordance with additional blocks of the process 400 (e.g., blocks 402, 410, 412).

At block 410, the controller determines the pixel location is within the modulated region. The controller may determine if a pixel location is within the modulated region by comparing the pixel location to the modulated region boundaries. For example, in an instance in which the modulated region is defined by a maximum distance, the controller may determine a distance from the pixel location to a center portion, center point, center line, or other indicator. If the determined distance is greater than the maximum distance, the pixel location is within the modulated region.

In an instance in which the modulated region boundaries are defined by a horizontal location (e.g., x location), the horizontal location of the pixel location may be compared to the modulated region boundaries. In an instance in which the horizontal location is less than the minimum horizontal location or greater than the maximum horizontal location, the pixel location is within the modulated region.

At block 412, the controller adjusts an optical output brightness of the optical output such that a pixel brightness at the pixel location is at the maximum pixel brightness. In a laser beam scanning projection system, the pixel brightness may be controlled by the adjusting the output power of the optical output. The output power of the optical output may be adjusted by adjusting the drive current of the one or more light sources within the optical engine. For example, reducing the drive current to the one or more light sources may reduce the output power of the optical output and the subsequent brightness of the corresponding pixel.

The controller of the laser beam scanning projection system is electrically connected to the optical engine and configured to transmit optical control signals to the optical engine. The optical control signals may be utilized by the controller to adjust the drive current to the one or more light sources within the optical engine. For example, the controller could specify a particular output power (e.g., in lumens), a value corresponding to an output power, a percentage of the maximum output power, or another parameter to adjust the output power of the optical output and the corresponding pixel brightness.

The controller is configured to reduce the drive current/output power of the optical output for pixel locations falling within the modulated region. In some embodiments, the controller is configured to adjust the brightness of the pixel locations such that the pixel brightness of the pixel locations in the modulated region are set at or near the maximum pixel brightness. Thus, the overall brightness of the display image may be maximized without adversely affecting the image quality.

Any pixel location not falling within the modulated region is within the unmodulated region of the display image. The pixel brightness of pixels within the unmodulated region is unaltered. Thus, all pixels within the unmodulated region maintain the intended brightness values.

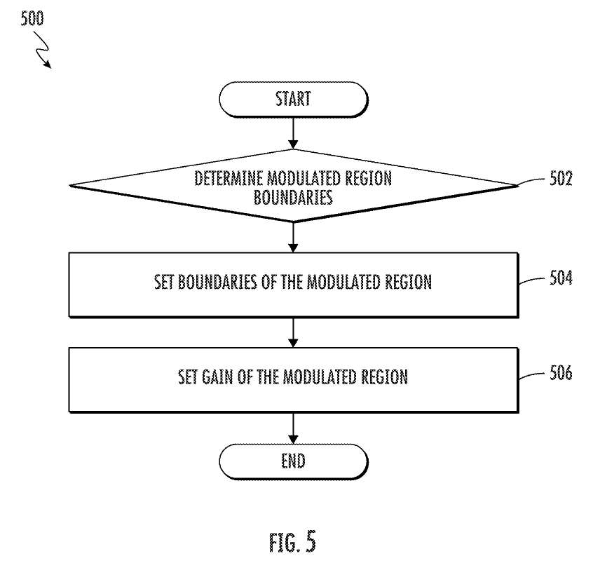

Referring now to FIG. 5, an example flow diagram depicting an example process 500 for modulating an optical output of a laser beam is provided. In some embodiments, the process 500 may be executed by a controller, for example controller 102 as described herein. The process 500 may be executed as part of a calibration process, for example, during manufacturing.

At step 502, the controller (e.g., controller 102) may determine modulation boundaries. The controller may determine modulation boundaries based on a maximum pixel brightness. The maximum pixel brightness may be selected to maximize the overall brightness of the display image without adversely affecting the quality of the display image. For example, the maximum brightness may be selected such that the variation in brightness on the display image is within an undetectable range. An undetectable range may correspond to a range of brightness levels in which a change in brightness is undetectable. For example, in visual applications, the human eye may be unable to detect changes within 20%. Thus, a maximum pixel brightness may be set at 120% of the minimum pixel brightness. In this way, changes to the pixel brightness may be undetectable to the human eye. Thus, the modulated region boundaries may be determined based on the maximum pixel brightness for which a variation in brightness is undetectable.

The controller may utilize any mechanism to determine the minimum pixel brightness. For example, the controller may measure or cause to be measured, the pixel brightness at various locations on the display image. In some embodiments, the location of the minimum pixel brightness may be determined or approximated based on the scanning pattern of the scanning system (e.g., scanning system 106). For example, the location of a minimum pixel brightness may be determined based on the speed of the scanning system (e.g., maximum speed) and/or the optical output dwell time (e.g., minimum optical output dwell time) associated with the scanning system.

In a raster scanning process, the scanning system moves quickly from one side of the display image to the other in a first direction as it progresses one line at a time in a second direction. In an instance in which the first direction is a horizontal direction, the minimum pixel brightness corresponds with a vertical line (e.g., vertical center line 223) at the horizontal center of the display image. In the raster scanning process, the vertical center line corresponds with the maximum speed of the scanning system and the minimum dwell time of the optical output. Thus, the minimum pixel brightness may be determined by measuring the pixel brightness at or near a center portion of the display image. For example, at or near the vertical center line. The maximum pixel brightness is based o the minimum pixel brightness, for example, the maximum variation from the minimum pixel brightness for which the variation in brightness is undetectable (e.g., 120% of the minimum pixel brightness.

The modulated region boundaries may indicate the portions of the display image at which the pixel brightness of the corresponding pixel locations are above the maximum pixel brightness. The modulated region boundaries may be determined using any mechanism. For example, measuring various pixel brightness values at various portions of the display image and indicating the one or more regions of the display image for which the pixel brightness exceeds the maximum pixel brightness.

In a raster scanning process, in which the first direction is a horizontal direction, the modulated region boundaries may correspond to a minimum horizontal location and a maximum horizontal location. Any pixel locations below the minimum horizontal location or pixel locations above the maximum horizontal location may be included in the modulated region. The controller may measure pixel brightnesses at various pixel locations, utilize scanning system speeds, and/or optical output dwell times to determine the minimum horizontal location and/or maximum horizontal location.

At step 504, the controller sets the boundaries of the modulated region. The controller may utilize any mechanism to indicate the pixel locations within the modulated region. For example, in a raster scanning process, the controller may write the minimum horizontal location and the maximum horizontal location to a memory location. Any pixel locations with a horizontal location (e.g., x value) less than the minimum horizontal location, or a horizontal location (e.g., x value) greater than the maximum horizontal location falls within the modulated region. Thus, the minimum horizontal location and maximum horizontal location correspond to vertical lines in the display image. In some embodiments, the controller may specify a maximum distance from a pixel location or locations having a minimum pixel brightness, for example, a maximum lateral distance from the center portion (e.g., of the vertical center line) of the display image. Any pixel location beyond the maximum distance from the pixel location or locations having the minimum pixel brightness may be within the modulated region.

At step 506, the gain (e.g., pixel brightness) of the modulated region is set. In some embodiments, the gain of pixels within the modulated region may correspond to a pixel brightness relative to the minimum pixel brightness. For example, the pixel brightness of the modulated region may be determined such that a variation in pixel brightness between the one or more pixel locations exhibiting a minimum pixel brightness and the pixels in the modulated region is undetectable. In some embodiments, the pixel brightness may be undetectable if variations in pixel brightness are not greater than 20%. Thus, the pixel brightness (e.g., gain) of the modulated region may be set to 120% of the minimum pixel brightness. During operation, any pixel with a pixel location within the modulated region may be configured such that the pixel brightness is at 120% of the pixel brightness of the minimum pixel brightness. In some embodiments, pixel brightness may be controlled by adjusting a drive current of one or more light sources of the optical engine generating the optical output.

During operation of a laser beam scanning projection system, pixels having pixel locations outside of the modulated region (e.g., unmodulated region) may maintain an unmodulated pixel brightness. Thus, no adjustments to the drive current of one or more light sources of the optical engine are made for pixel locations in the unmodulated region. By maintaining the pixel brightness for pixel locations in the unmodulated region, the overall brightness of the display image may be increased relative to modulation algorithms enforcing a uniform pixel brightness.

Referring now to FIG. 6, an example graph 600 depicting a brightness distribution 606 before the modulation process (e.g., process 400, process 500) is applied, is provided. As shown in the graph 600, the brightness distribution 606 is at a minimum pixel brightness 608 near the center of an illustrative display image (e.g., display image 228). While the brightness distribution 606 remains relatively close to the minimum pixel brightness 608 near the center of the display image, the brightness distribution 606 near the edges of the display image is significantly higher than the minimum pixel brightness 608 at the center of the display image. Such a variation in brightness may adversely the quality of the display image.

As further depicted in FIG. 6, the example graph 602 depicts a brightness distribution 610 after applying a modulation process (e.g., process 400, process 500) in accordance with one or more example embodiments of the present disclosure. As depicted in the graph 602, a plurality of boundaries (e.g., boundary line 614a, boundary line 614b) of the modulated region 616 are provided.

As depicted in graph 602, a maximum pixel brightness 612 (e.g., 120%) is determined based on the minimum pixel brightness 608. For example, the maximum pixel brightness 612 is 120% of the minimum pixel brightness 608. Any pixel location with a pixel brightness exceeding the maximum pixel brightness 612 is included in the modulated region 616, while any pixel location with a pixel brightness below the maximum pixel brightness 612 is included in the unmodulated region 618.

As depicted in graph 602, the boundary lines 614a, 614b are determined based on pixel locations at which the pixel brightness exceeds the maximum pixel brightness 612. For example, based on the brightness distribution 606 shown in graph 600, the pixel brightness of the pixel locations in the edge region, less than the boundary line 614a, exceed the maximum pixel brightness 612. Similarly, the pixel brightness of the pixel locations in the edge region, greater than the boundary line 614b, exceed the maximum pixel brightness 612. As described herein, the boundary lines 614a, 614b may be determined by any mechanism utilized to determine the pixel brightness at pixel locations exceeds the maximum pixel brightness 612. In a raster scanning process, the boundary lines 614a, 614b may correspond to horizontal locations on a display image. Any pixel locations with a horizontal location (e.g., x value) less than the minimum horizontal location (e.g., boundary line 614a) are included in the modulated region 616. Similarly, any pixel locations with a horizontal location (e.g., x value) greater than the minimum horizontal location (e.g., boundary line 614a) are also included in the modulated region 616. As shown in graph 602, the locations of the boundary lines 614a, 614b may correspond to a normalized position on the display image. For example, the first boundary line 614a is positioned at or near 20% of the display image width, while the second boundary line 614b is positioned at or near 80% of the display image height. Although depicted as a percentage of the display image width, in some embodiments, the boundary lines 614a, 614b may correspond to a percentage of the display image height.

As further depicted in graph 602, the pixel locations in the unmodulated region 618 maintain their pixel brightness without adjustment, for example, no adjustments to the drive current of one or more light sources of the optical engine are made for pixel locations in the unmodulated region 618. In some embodiments, the unmodulated region 618 may comprise more than 40% of the display image; more preferably, more than 50% of the display image; most preferably more than 60% of the display image. Maximizing the unmodulated region without allowing a perceptible pixel brightness variation may improve the quality of the display image.

As further depicted in FIG. 6, the example graph 604 depicts the lost brightness 620 based on the unmodulated brightness distribution 606 depicted in graph 600 compared to the modulated brightness distribution 610 depicted in the graph 602. Minimizing the lost brightness 620 while limiting pixel brightness variance to undetectable levels maximizes the quality of the display image. As shown in example graph 604, the pixel brightness for pixel locations in the unmodulated region 618 (e.g., near the center region) of the display image are not altered. As further shown in graph 604, the pixel brightness of the pixel locations in the modulated region are capped at the maximum pixel brightness 612 (e.g., 120% of the minimum pixel brightness 608). Determining the unmodulated region/regions 618 and the modulated region/regions 616 and capping the pixel brightness in the modulated regions 616 at a pixel brightness above the minimum pixel brightness 608, minimizes the lost brightness 620 while avoiding detectable pixel brightness variance.

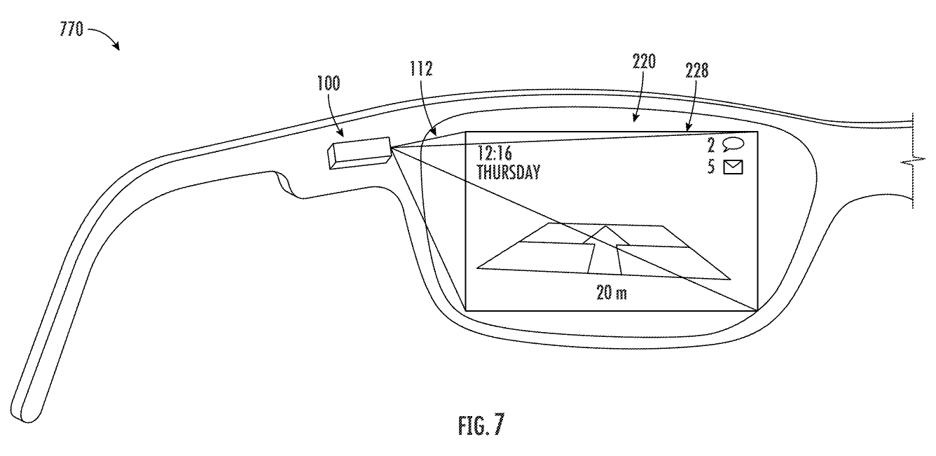

Referring now to FIG. 7, an example head-worn display 770 comprising a laser beam scanning projection system 100 in accordance with the present disclosure, is provided. As depicted in FIG. 7, a laser beam scanning projection system 100 may be mounted or attached to a head-worn display 770 such that the optical output 112 is directed to render a display image 228 on a display surface 220.

As depicted in FIG. 7, in some embodiments, the display surface 220 may comprise a transparent or semi-transparent surface, such as a lens. In such an embodiment, the display image 228 may be visible to a user while still allowing the user to see through the display surface. Such a display surface 220 may be particularly useful in a smart glasses system, or other similar augmented reality or mixed reality system. The modulation processes (e.g., process 400, process 500) of the present disclosure may enhance the image quality of display images 228 on a head-worn display 770.

Although the laser beam scanning projection system 100 is depicted on a head-worn display 770 in FIG. 7, the laser beam scanning projection system 100 may be incorporated within any system using a scanning system to direct an optical output in order to render a display image on a display surface. For example, smart glasses, virtual reality systems, augmented reality systems, a head’s up display, digital light processing projectors, structured light scanners, and other image projection systems.

Referring now to FIG. 8, FIG. 8 illustrates an example controller 102 in accordance with at least some example embodiments of the present disclosure. The controller 102 includes processor 802, input/output circuitry 804, data storage media 806, and communications circuitry 808. In some embodiments, the controller 102 is configured, using one or more of the sets of circuitry 802, 804, 806, and/or 808, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the controller 102 provide or supplement the functionality of other particular sets of circuitry. For example, the processor 802 in some embodiments provides processing functionality to any of the sets of circuitry, the data storage media 806 provides storage functionality to any of the sets of circuitry, the communications circuitry 808 provides network interface functionality to any of the sets of circuitry, and/or the like.

In some embodiments, the processor 802 (and/or co-processor or any other processing circuitry assisting or otherwise associated with the processor) is/are in communication with the data storage media 806 via a bus for passing information among components of the controller 102. In some embodiments, for example, the data storage media 806 is non-transitory and may include, for example, one or more volatile and/or non-volatile memories. In other words, for example, the data storage media 806 in some embodiments includes or embodies an electronic storage device (e.g., a computer readable storage medium). In some embodiments, the data storage media 806 is configured to store information, data, content, applications, instructions, or the like, for enabling the controller 102 to carry out various functions in accordance with example embodiments of the present disclosure.

The processor 802 may be embodied in a number of different ways. For example, in some example embodiments, the processor 802 includes one or more processing devices configured to perform independently. Additionally, or alternatively, in some embodiments, the processor 802 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the controller 102, and/or one or more remote or “cloud” processor(s) external to the controller 102.

In an example embodiment, the processor 802 is configured to execute instructions stored in the data storage media 806 or otherwise accessible to the processor. Alternatively, or additionally, the processor 802 in some embodiments is configured to execute hard-coded functionality. As such, whether configured by hardware or software methods, or by a combination thereof, the processor 802 represents an entity (e.g., physically embodied in circuitry) capable of performing operations according to an embodiment of the present disclosure while configured accordingly. Alternatively, or additionally, as another example in some example embodiments, when the processor 802 is embodied as an executor of software instructions, the instructions specifically configure the processor 802 to perform the algorithms embodied in the specific operations described herein when such instructions are executed.

In some embodiments, the controller 102 includes input/output circuitry 804 that provides output to the user and, in some embodiments, to receive an indication of a user input. In some embodiments, the input/output circuitry 804 is in communication with the processor 802 to provide such functionality. The input/output circuitry 804 may comprise one or more user interface(s) (e.g., user interface) and in some embodiments includes a display that comprises the interface(s) rendered as a web user interface, an application user interface, a user device, a backend system, or the like. The processor 802 and/or input/output circuitry 804 comprising the processor may be configured to control one or more functions of one or more user interface elements through computer program instructions (e.g., software and/or firmware) stored on a memory accessible to the processor (e.g., data storage media 806, and/or the like). In some embodiments, the input/output circuitry 804 includes or utilizes a user-facing application to provide input/output functionality to a client device and/or other display associated with a user.

In some embodiments, the controller 102 includes communications circuitry 808. The communications circuitry 808 includes any means such as a device or circuitry embodied in either hardware or a combination of hardware and software that is configured to receive and/or transmit data from/to a network and/or any other device, circuitry, or module in communication with the controller 102. In this regard, the communications circuitry 808 includes, for example in some embodiments, a network interface for enabling communications with a wired or wireless communications network. Additionally, or alternatively in some embodiments, the communications circuitry 808 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 808 includes circuitry for interacting with the antenna(s) and/or other hardware or software to cause transmission of signals via the antenna(s) or to handle receipt of signals received via the antenna(s). In some embodiments, the communications circuitry 808 enables transmission to and/or receipt of data from a client device in communication with the controller 102.

Additionally, or alternatively, in some embodiments, one or more of the sets of circuitry 802-814 are combinable. Additionally, or alternatively, in some embodiments, one or more of the sets of circuitry perform some or all of the functionality described associated with another component. For example, in some embodiments, one or more sets of circuitry 802-808 are combined into a single module embodied in hardware, software, firmware, and/or a combination thereof. Similarly, in some embodiments, one or more of the sets of circuitry is/are combined such that the processor 802 performs one or more of the operations described above with respect to each of these circuitry individually.

While this detailed description has set forth some embodiments of the present invention, the appended claims cover other embodiments of the present invention which differ from the described embodiments according to various modifications and improvements. For example, one skilled in the art may recognize that such principles may be applied to any projection system utilizing a scanning system to project a display image on a display surface. For example, example, smart glasses, virtual reality systems, augmented reality systems, head’s up displays, digital light processing projectors, structured light scanners, and other image projection systems.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. An apparatus comprising:
an optical engine configured to generate an optical output corresponding to a pixel location in a display image;
a scanning system configured to project the optical output to the pixel location on a display surface displaying the display image;
a controller configured to:
determine a minimum pixel brightness associated with the display image;
determine a maximum pixel brightness greater than the minimum pixel brightness;
determine a modulated region of the display image based on the maximum pixel brightness;
determine the pixel location is within the modulated region; and
adjust an optical output brightness of the optical output such that a pixel brightness at the pixel location is at the maximum pixel brightness.

2. The apparatus of claim 1, wherein the maximum pixel brightness is 120% of the minimum pixel brightness.

3. The apparatus of claim 1, wherein the minimum pixel brightness is based on a center pixel brightness corresponding to a center pixel location proximate a center of the display image.

4. The apparatus of claim 1, wherein the scanning system is configured to project the optical output associated with a plurality of pixel locations in a raster pattern.

5. The apparatus of claim 1, wherein the modulated region is determined based on a distance from a center line of the display image.

6. The apparatus of claim 5, wherein the modulated region is defined by a maximum lateral distance from the vertical center line of the display image.

7. The apparatus of claim 6, wherein the maximum lateral distance corresponds to a point at which a corresponding pixel brightness exceeds the maximum pixel brightness.

8. The apparatus of claim 1, wherein the pixel brightness is measured in lux.

9. The apparatus of claim 1, wherein the pixel brightness is based on an optical output dwell time.

10. A method for modulating an optical output of a laser beam scanning projection system, the method comprising:
causing an optical engine to generate the optical output corresponding to a pixel location in a display image, wherein the optical output is directed by a scanning system to the pixel location on a display surface displaying the display image;
determining a minimum pixel brightness associated with the display image;
determining a maximum pixel brightness greater than the minimum pixel brightness;
determining a modulated region of the display image based on the maximum pixel brightness;
determining the pixel location is within the modulated region; and
adjusting an optical output brightness of the optical output such that a pixel brightness at the pixel location is at the maximum pixel brightness.

11. The method of claim 10, wherein the maximum pixel brightness is 120% of the minimum pixel brightness.

12. The method of claim 10, wherein the minimum pixel brightness is based on a center pixel brightness corresponding to a center pixel location proximate a center of the display image.

13. The method of claim 10, wherein the scanning system is configured to project the optical output associated with a plurality of pixel locations in a raster pattern.

14. The method of claim 10, further comprising:
determining a maximum lateral distance from a vertical center line of the display image corresponding to a point at which a corresponding pixel brightness exceeds the maximum pixel brightness; and
defining the modulated region based on the maximum lateral distance from the vertical center line of the display image.

15. The method of claim 14, wherein any pixel location having a pixel lateral distance from the vertical center line of the display image exceeding the maximum lateral distance is within the modulated region of the display image.

16. The method of claim 10, wherein the pixel brightness is measured in lux.

17. The method of claim 10, wherein the pixel brightness is based on an optical output dwell time.

18. A head-worn wearable display comprising:
a display surface; and
a laser beam scanning projection system configured to project a display image on the display surface, the laser beam projection system comprising:
an optical engine configured to generate an optical output corresponding to a pixel location on the display surface;
a scanning system configured to project the optical output to the pixel location on the display surface;
a controller configured to:
determine a minimum pixel brightness associated with the display surface;
determine a maximum pixel brightness greater than the minimum pixel brightness;
determine a modulated region of the display surface based on the maximum pixel brightness;
determine the pixel location is within the modulated region; and
adjust an optical output brightness of the optical output such that a pixel brightness at the pixel location is at the maximum pixel brightness.

19. The head-worn wearable display of claim 18, wherein the maximum pixel brightness is 120% of the minimum pixel brightness.

20. The head-worn wearable display of claim 18, wherein the display surface is transparent.
